(19) United States
(12) Patent Application Publication
(10) Pub. No.: US 2024/0344925 A1
(43) Pub. Date: Oct. 17, 2024

(54) ELECTRONIC SYSTEM FOR MODELING AN AIRCRAFT IN A TESTING TUNNEL AND A METHOD

(71) Applicant: The Boeing Company, Arlington, VA (US)

(72) Inventors: Bradley Jerome Rafferty, Saint Louis, MO (US); Paul Conrad Crnic, Saint Louis, MO (US)

(73) Assignee: The Boeing Company, Arlington, VA (US)

(21) Appl. No.: 18/301,222

(22) Filed: Apr. 15, 2023

(51) Int. Cl. G01M 9/08; G06F 30/15

(52) U.S. Cl. CPC G01M 9/08; G06F 30/15; G06F 2111/02

(57) ABSTRACT

A method and an electronic system for modeling an aircraft in a testing tunnel includes a scale model of the aircraft in which a plurality of components is installed in the testing tunnel to form a first model configuration. Each of the components includes an identifier having unique identification information for the respective components. Each of the components is identifiable by the identifier when installed in the testing tunnel for the first model configuration. A host machine is configured to select data about the components installed for the first model configuration. The host machine is configured to execute instructions from a memory, via a processor. The host machine is configured to receive the unique identification information from the components of the first model configuration, determine if the unique identification information corresponds to the selected data, and output a notification if the selected data does not match the unique identification information.

### BACKGROUND

Wind tunnels have been used to compile data about aerodynamics of a physical aircraft model, which may be used to develop aircraft. Therefore, a wind tunnel may be operated to compile data about aerodynamics of various aircraft components from each operation of the wind tunnel. Many test runs may occur as the configuration of the aircraft model changes. Aircraft components may be hundreds of separate parts, and some of the aircraft components may also have subsets of parts. For example, there may be many different wing configurations that may be interchanged with a single fuselage, and each of the wing configurations may have many different control surfaces, such as flaps, slats, ailerons, etc.; and these control surfaces may be in a different orientation for each of the test runs. Or, for example, different fuselages may be interchanged with various wing configurations or different tail features may be interchanged with various fuselages.

Generally, identification of the aircraft components being tested is done by reading the part number off of the physical component or by visually inspecting the physical component, and then the identification data is manually logged in a static file. This visual checking of the part numbers of the physical components or visually inspecting the physical component assembled in the wind tunnel is also used to determine if the actual assembled aircraft model matches the desired aircraft model to be tested in the wind tunnel. However, mistakes may occur by reading the part number off of the aircraft components or by visually inspecting the aircraft components, and the process of visually checking the part numbers or the components may be a time-consuming task.

In addition, the data compiled from operation of the wind tunnel is logged through manual bookkeeping by manually recording the associated wind tunnel model data with that particular test run of the wind tunnel into the static file. The test run data is manually recorded with the corresponding description of each of the aircraft components of that aircraft model. Due to the many different aircraft components, and thus, the many different possible aircraft models, mistakes may occur when manually recording the identification data and/or manually recording the data compiled from operation of the wind tunnel.

Furthermore, the static file may be modified by anyone that has access to the static file, and thus, additional information may be added into the static file, any of the information may be deleted from the static file, or any of the information may be modified in the static file by anyone that has access to the static file. The data compiled by manual bookkeeping all of these test runs, the different aircraft models, the different aircraft components, may be very large, and thus, this data may be prone to mistakes by misspelling some of the information, incorrectly entering the part numbers, accidently adding or deleting some of the information, or any other mistakes that may occur by manual bookkeeping.

### SUMMARY

Therefore, it is desirable to develop an electronic system and a method to reduce mistakes when modeling an aircraft in a testing tunnel, and automatically notify a user of an undesirable aircraft component being modeled in a testing tunnel.

The present disclosure pertains to an electronic system for modeling an aircraft in a testing tunnel. The electronic system includes a scale model of the aircraft. The scale model includes a plurality of components installed in the testing tunnel to form a first model configuration. Each of the components includes an identifier having unique identification information for the respective components. Each of the components is identifiable by the identifier when the respective components are installed in the testing tunnel for the first model configuration. The electronic system further includes a host machine configured to select data about the components installed for the first model configuration. The host machine is configured to execute instructions from a memory, via a processor. The host machine is configured to receive the unique identification information from the components of the first model configuration, determine if the unique identification information corresponds to the selected data, and output a notification if the selected data does not match the unique identification information.

The present disclosure also pertains to a method of modeling an aircraft in a testing tunnel. A plurality of components is installed in the testing tunnel to form a first model configuration. The components installed in the testing tunnel are a scale model of the aircraft, and each of the components includes an identifier having unique identification information for the respective components. Data is selected, via a host machine, about the components installed for the first model configuration. The host machine is configured to execute instructions from a memory, via a processor. Each of the components installed in the testing tunnel for the first model configuration is identified, via the identifier. The host machine receives the unique identification information from the components of the first model configuration. The method also includes determining if the unique identification information corresponds to the selected data. A notification is outputted if the selected data does not match the unique identification information.

The detailed description and the drawings or FIGS. are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic illustration of an electronic system of a testing tunnel having an aircraft model installed in the testing model.

FIG. 2 is a schematic illustration of the electronic system using an identifier of a first configuration.

FIG. 3 is a schematic illustration of the electronic system using an identifier of a second configuration.

FIG. 4 is a schematic illustration of the electronic system using an identifier of a third configuration.

FIG. 5 is a schematic illustration of an electrical circuit of the identifier of the third configuration.

FIG. 6 is a flow chart of a method of modeling an aircraft in a testing tunnel.

The present disclosure may be extended to modifications and alternative forms, with representative configurations shown by way of example in the drawings and described in detail below. Inventive aspects of the disclosure are not limited to the disclosed configurations. Rather, the present disclosure is intended to cover modifications, equivalents, combinations, and alternatives falling within the scope of the disclosure as defined by the appended claims.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims. Moreover, terms such as “first,” “second,” “third,” and so on, may be used to describe separate components. Such terminology may include the words specifically mentioned above, derivatives thereof, and words of similar import. Furthermore, the term “substantially” can refer to a slight imprecision or slight variance of a condition, quantity, value, or dimension, etc., some of which are within manufacturing variance or tolerance ranges.

As used herein, an element or step recited in the singular and preceded by the word “a” or “an” should be understood as not necessarily excluding the plural of the elements or steps. Further, any reference to “one configuration” is not intended to be interpreted as excluding the existence of additional configurations that also incorporate the recited features. Moreover, unless explicitly stated to the contrary, configurations “comprising” or “having” an element or a plurality of elements having a particular property may include additional elements not having that property. The phrase “at least one of” as used herein should be construed to include the non-exclusive logical “or”, i.e., A and/or B and so on depending on the number of components.

Furthermore, the teachings may be described herein in terms of functional and/or logical block components and/or various processing steps. It should be realized that such block components may be comprised of any number of hardware, software, and/or firmware components configured to perform the specified functions.

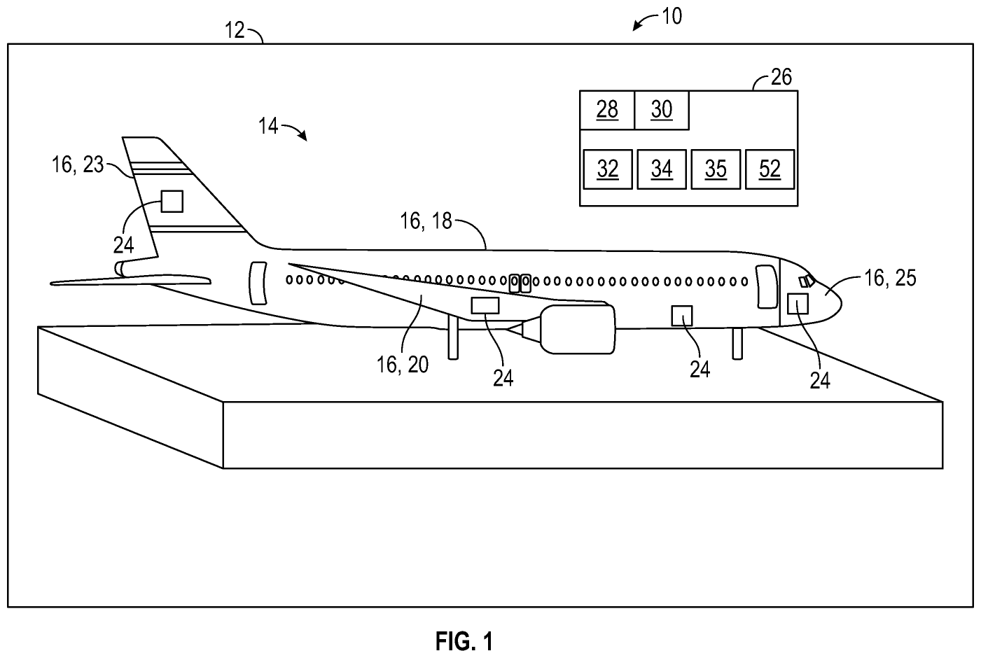

Referring to the figures, wherein like numerals indicate like or corresponding parts throughout the several views, an electronic system 10 for modeling an aircraft in a testing tunnel 12 is generally shown in FIG. 1. Generally, the electronic system 10 may detect a configuration of a physical aircraft model installed in the testing tunnel 12 and provide a signal if the aircraft model installed does not match a desired configuration of the aircraft to be tested. If the desired configuration of the aircraft model is installed in the testing tunnel 12, then a test run is allowed to proceed, which will be discussed in detail below. As such, the electronic system 10 generally provides a way to ensure that the aircraft model installed in the testing tunnel 12 is the desired aircraft configuration to be tested. As will be discussed below, the electronic system 10 provides a robust, automated recording of the configuration of the aircraft model in order to reduce escapes in the quality of data produced by the testing tunnel 12, which may improve the overall productivity of installing the aircraft model as well as improve the quality of the data produced, while also reducing the amount of manual recording required.

Generally, when referring to the aircraft, this may include any part of the aircraft and any type of aircraft. For example, types of aircraft may include commercial aircraft, private aircraft, personal aircraft, aircraft with payloads, military aircraft, helicopters, vertical take-off and landing (VTOL) aircraft, gliders, space shuttles, drones, payloads, or any other airborne structures. Furthermore, the aircraft may be any type of aircraft that is un-manned or manned. It is to be appreciated that other physical models may be installed in the testing tunnel 12, such as, but not limited to vehicles, cars, trucks, motorcycles, bicycles, watercrafts, marine vehicles, etc.

Also, the aircraft used for testing is a scale model 14 of a full-size aircraft. A scale of the scale model 14 may be greater than zero percent scale to less than or equal to one-hundred percent scale. Therefore, depending on the size of the testing tunnel 12, a full-size aircraft may be the scale model 14, or any reduced sized aircraft may be the scale model 14. That is, the scale model 14 of the aircraft is sized to be able to fit into the testing tunnel 12, and thus, is generally a reduced size of the full-size aircraft. The scale model 14 is easier to manufacture and maneuver, as well as provide a more convenient testing tunnel 12 environment, and thus, a more economical and productive environment to perform testing as compared to flight-testing a full-size, fully-operational aircraft. A scale model 14 of less than one-hundred percent scale may be easier to manufacture, reduce manufacturing costs, and enter into more testing tunnel facilities as compared to larger scale models.

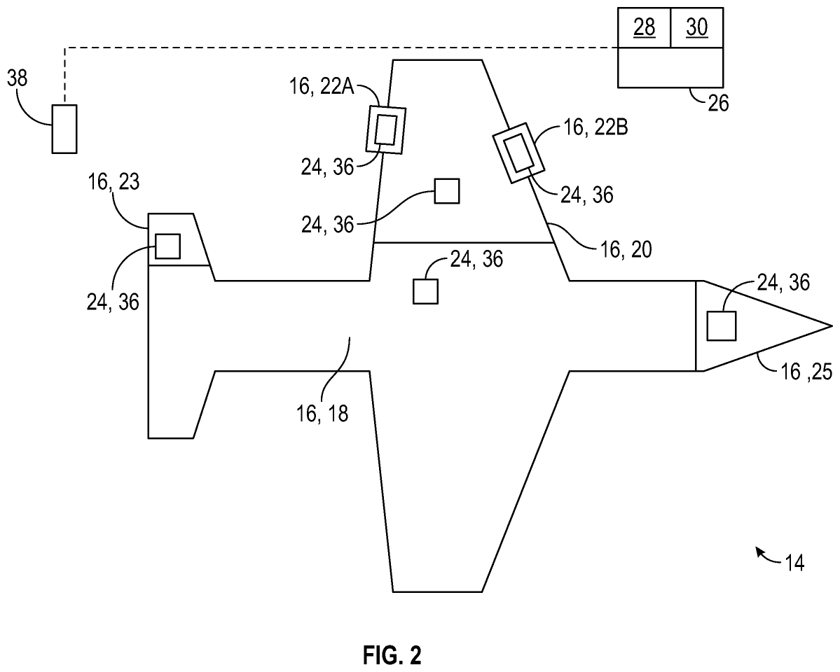

The electronic system 10 includes the scale model 14 of the aircraft. The below discussion may refer to the aircraft, and it is to be appreciated that this is referring to the scale model 14 being used with the electronic system 10 and testing in the testing tunnel 12. It is to be appreciated that referring to the aircraft model may also be referring to the scale model 14. Also, referring to the figures, the scale model 14 has been simplified in FIGS. 2-5 for illustrative purposes as compared to FIG. 1, and therefore, any of FIGS. 2-5 may replace the detailed scale model 14 in FIG. 1, or FIG. 1 may replace the simplified scale models 14 of FIGS. 2-5. In addition, it is to be appreciated that the testing tunnel 12 of FIG. 1 has been simplified, and one skilled in the art appreciates that there may be supports above and/or below the scale model 14 when assembled in the testing tunnel 12.

The aircraft includes a plurality of components 16 installed in the testing tunnel 12 to form a first model configuration. The components 16 may be any configuration to be tested in the testing tunnel 12. Some non-limiting examples of the components 16 may include fuselages 18, wings 20, high-lift devices 22A, 22B including flaps 22A, slats 22B, (or any other suitable high-lift devices 22A, 22B), tails 23, noses 25, stabilizers, rudders, elevators, and/or any other components 16 to be installed into the testing tunnel 12. Since there are many different types of aircraft, as discussed above, it is to be appreciated that the components 16 may include any number of different configurations of the same part. Therefore, for example, different aircrafts may have different noses or different fuselages 18 or different wings 20, and so on; as such, the components 16 may include any number of different noses, different fuselages 18, different wings 20, and so on.

Each of the components 16 includes an identifier 24 having unique identification information for the respective components 16. Each of the components 16 is identifiable by the identifier 24 when the respective components 16 are installed in the testing tunnel 12 for the first model configuration. The unique identification information may include a physical description of that particular corresponding component 16, which may describe that particular component 16, may provide a part number for that particular component 16, and/or may provide any other suitable information related to that particular component 16. Therefore, for example, the unique identification information for each of the wings 20 may have a different part number, a different description, etc. Similarly, for example, the unique identification information for each of the high-lift devices 22A, 22B may have a different part number, a different description, etc. Generally, the identifiers 24, and associated unique identification information, are used to ensure that the appropriate components 16 are installed and tested in the testing tunnel 12, as discussed further below. Furthermore, the identifiers 24 assist in ensuring that the actual or physically installed scale model 14 is the desired aircraft model to be tested and assists in automating the recording of the unique identification information/the information about the scale model 14.

The electronic system 10 includes a host machine 26 configured to select data about the components 16 installed for the first model configuration. Therefore, for example, a user may access the host machine 26 to select the desired components 16 to be installed in the testing tunnel 12, which will define the first model configuration. That is, the user selects the components 16, using the host machine 26, to form the desired first model configuration that the user plans to run testing on in the testing tunnel 12. The host machine 26 is used for other processes, which will be discussed further below.

The host machine 26 may be configured to execute instructions from a memory 28, via a processor 30. That is, the instructions may be stored in the memory 28 of the host machine 26 and automatically executed via the processor 30 of the host machine 26 to provide the respective control functionality. For example, the host machine 26 may include a controller or distributed system, e.g., a computer such as a digital computer or microcomputer, and, as the memory 28, tangible, non-transitory computer-readable memory such as read-only memory (ROM), whether optical, magnetic, or flash memory 28, or otherwise. The host machine 26 may also have random access memory (RAM), electrically erasable programmable read-only memory (EEPROM), a high-speed clock, analog-to-digital (A/D) and/or digital-to-analog (D/A) circuitry, and any required input/output circuitry and associated devices, as well as any required signal conditioning and/or signal buffering circuitry.

Therefore, the host machine 26 may include all software, hardware, memory 28, algorithms, connections, sensors, etc., necessary to perform the processes and method 100 as discussed herein. For example, the host machine 26 may be used to compare the actual installed scale model 14 of the aircraft with the intended first model configuration to be tested, which may be embodied as software or firmware associated with the host machine 26. It is to be appreciated that the host machine 26 may also include any device capable of analyzing data from the identifiers 24, comparing data, making the necessary decisions required to control and/or monitor the scale model 14, output/store/use results from each of the test runs, etc. Optionally, more than one host machine 26 may be utilized and/or communicate with each other.

Generally, the memory 28 of the host machine 26 may include a library 32 containing a plurality of possible components 16 to be used to form a model configuration including the first model configuration. Therefore, for example, the library 32 may include a plurality of the fuselages 18, a plurality of the wings 20, a plurality of the high-lift devices 22A, 22B, a plurality of tails, a plurality of noses, a plurality of stabilizers, a plurality of rudders, a plurality of elevators, and any other components 16 of the aircraft. The data may be selected by accessing the library 32 and then selecting the desired components 16 from the possible components 16 from the library 32 to present the desired model configuration to be installed in the testing tunnel 12. The library 32 may include a look-up table, a database, etc. to access the possible components 16.

In addition, the host machine 26 may be configured to record and store, via the memory 28, results from operation of the testing tunnel 12 in a results database 34 of the memory 28. That is, each run of the testing tunnel 12 may produce results as the raw data, and that raw data is recorded and stored in the results database 34. Therefore, the data associated with the model configuration, such as the first model configuration, and the raw data from the results of that test run of that particular model configuration may be recorded and stored in the results database 34. The results database 34 may be accessed via the user through the host machine 26 such that the user may use the raw data for aircraft development, aircraft improvements, aircraft designs, etc. The host machine 26 may automatically record and store the results, instead of manually recording/storing this information in a static file.

Turning to the testing tunnel 12, the testing tunnels 12 may be used to collect exploratory data and/or used to generate databases of information, such as the results database 34, about the scale model 14 of the aircraft and associated performance depending on the type of testing tunnel 12 is being used, in which the results then may be used to design full-size aircraft. This information may be stored in the memory 28 and retrieved by the host machine 26. The testing tunnel 12 may be a different configuration depending on the type of test run being performed. Generally, the testing tunnel 12 may include a fluid testing tunnel configured to receive the selected model configuration, such as the first model configuration. For example, the fluid testing tunnel may be a gaseous fluid or a liquid fluid. In one configuration, the fluid testing tunnel 12 may be a wind testing tunnel, and the wind testing tunnel may use gaseous fluid such as air. In another configuration, the fluid testing tunnel may be an aquatic testing tunnel, and the aquatic testing tunnel may use liquid fluid such as water. The host machine 26 may be configured to store, via the memory 28, results from operation of the wind testing tunnel of the first model configuration in a first aerodynamic database of the memory 28. In addition, the host machine 26 may be configured to store, via the memory 28, results from operation of the aquatic testing tunnel of the first model configuration in a second aerodynamic database of the memory 28. Therefore, the results database 34 may include sub-databases, i.e., first aerodynamic database and second aerodynamic database, to categorize wind testing separately from aquatic testing, and so on depending on the type of the testing tunnel 12. FIG. 1 is representative of any type of testing tunnel 12 and any suitable host machine 26 that may cooperate with the different identifiers 24 of FIGS. 2-5. It is to be appreciated that the testing tunnel 12 may be other configurations depending on the desired type of test, and non-limiting examples may include vibration table testing, environmental chamber testing, etc.

The host machine 26 is configured to receive the unique identification information from the components 16 of the first model configuration. The host machine 26 may automatically record the unique identification information, instead of manually recording this information in the static file. The unique identification information is used to confirm that the components 16 installed in the testing tunnel 12 are the desired components 16 for the selected model configuration to be tested. The unique identification information may be communicated to the host machine 26 in various ways, some of which are discussed below.

The host machine 26 is also configured to determine if the unique identification information corresponds to the selected data. Therefore, the host machine 26 may compare information about the components 16 of the selected model configuration to be tested, such as the first model configuration, with the unique identification information of the components 16 actually or physically installed in the testing tunnel 12. Therefore, the host machine 26 may include an interface 35, such as a display, a tablet, a device, a screen, a speaker, etc., for the user to interact with, in order to make model selections, review test results, review information about the components 16, review information about whether the unique identification information corresponds to the selected data, etc.

Turning back to the identifier 24, the identifier 24 includes the unique identification information for the respective components 16, and the host machine 26 uses the unique identification information. Therefore, for example, the scale model 14 configuration may use the identifier 24 to continuously/periodically and automatically record which of the components 16 are installed in the testing tunnel 12, instead of visually inspecting the components 16 and manually logging the corresponding information in the static file. The identifier 24 may be presented in many different forms, and some non-limiting examples will be discussed herein, and are illustrated in FIGS. 2-5. It is to be appreciated that the host machine 26 in FIGS. 2-5 is simplified in these figures, and thus, the details of the host machine 26 of FIG. 1 may be used with the configurations of FIGS. 2-5.

For example, as shown in FIG. 2, the identifier 24 may include a radio frequency identification (RFID) tag 36 that stores the unique identification information for each of the components 16. The host machine 26 may include an RFID reader 38 configured to receive the unique identification information from each identifier 24. The host machine 26 may be configured to receive the unique identification information from the RFID reader 38. Therefore, the host machine 26 may be in communication with the RFID reader 38. At least one RFID tag 36 is attached or embedded in each of the components 16. The RFID reader 38 may be a handheld device that is positioned over each of the components 16 installed in the testing tunnel 12 to scan the RFID tag 36. Therefore, the RFID reader 38 may query each of the components 16 in each position of the installed scale model 14, and the RFID reader 38 may inventory and communicate the installed configuration to the host machine 26. It is to be appreciated that the RFID reader 38 may also be referred to as a scanner and the RFID tag 36 may also be referred to as a microchip or chip.

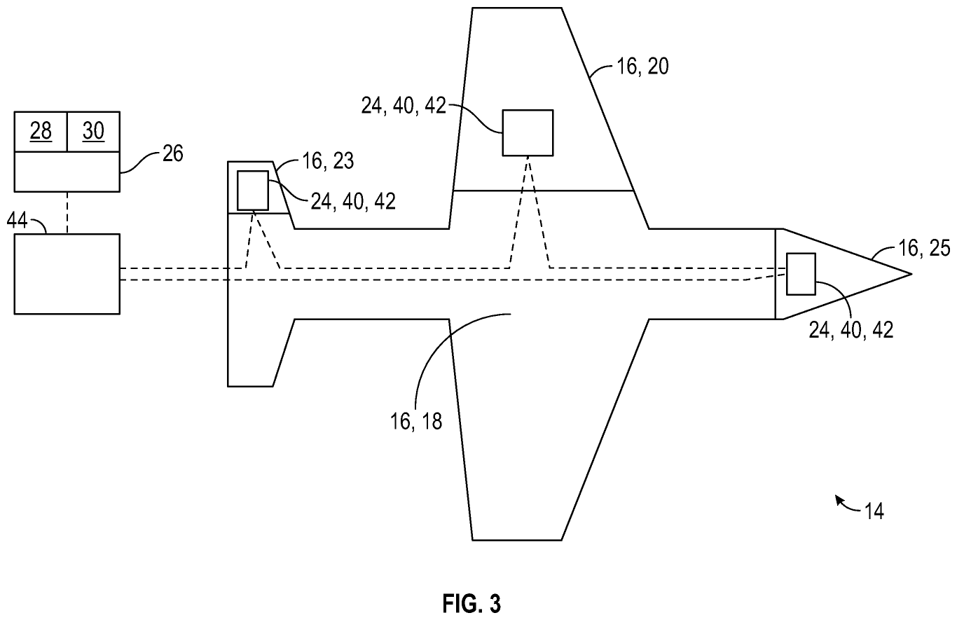

As another example, as shown in FIG. 3, the identifier 24 may include a transducer electronic data sheet (TEDS) chip 40 having a transducer 42. The TEDS chip 40 stores the unique identification information for each of the components 16. The host machine 26 may include a TEDS network 44 configured to receive the unique identification information from each identifier 24 via the transducer 42 of the TEDS chip 40. Therefore, the host machine 26 may be in communication with the TEDS network 44. At least one TEDS chip 40 is attached or embedded in each of the components 16. In certain configurations, the TEDS chip 40 may be an electrically erasable programmable read-only memory (EEPROM) chip 40. Also, in certain configurations, the TEDS chip 40 may include a strain gauge. In certain configurations, the TEDS network 44 may be hard wired to the installed scale model 14 or in wireless communication with each other, in order to communicate the unique identification information therebetween. Therefore, the lines between the TEDS chips 40 and the TEDS network 44 in FIG. 3 may represent hard-wiring or wireless communication therebetween.

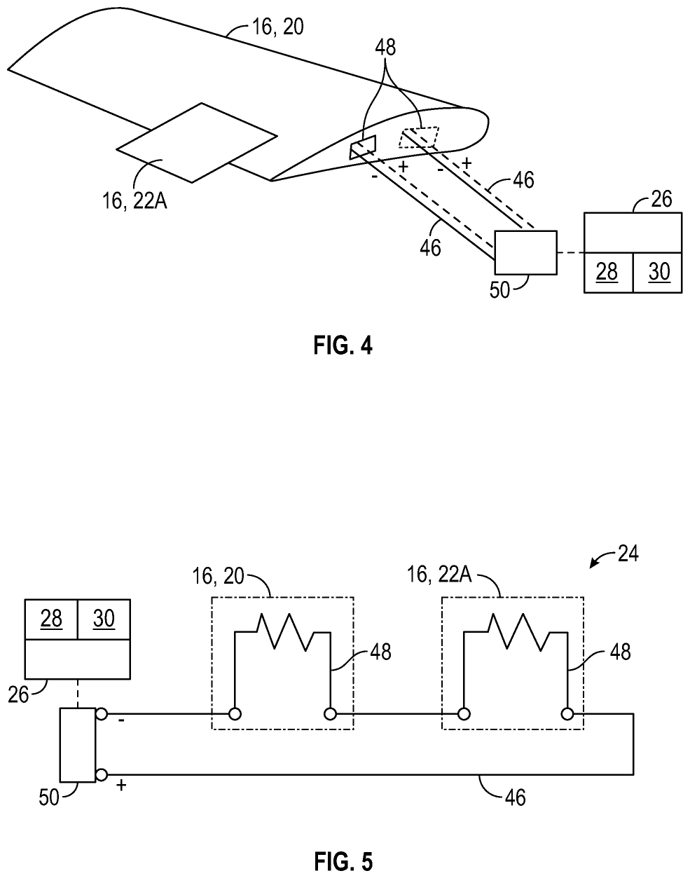

As yet another example, as shown in FIGS. 4 and 5, each of the components 16 may include electrical circuitry 46, and the electrical circuitry 46 may be used to create unique resistance as the unique identification information. Therefore, also in this configuration, the identifier 24 may include a resistor 48 having a predetermined resistance for each of the components 16. That is, the resistance of each component 16 is unique to that particular component 16. Generally, a respective resistor 48 is affixed to each of the components 16, and the respective resistor 48 is used to close a circuit via the electrical circuitry 46 when the scale model 14 is installed in the testing tunnel 12. Therefore, the scale model 14 may be hard-wired to form the electrical circuitry 46 with the resistors 48 closing the circuit. Regarding FIG. 4, the positive (+) electrical side of the electrical wires is shown in dashed lines for illustrative purposes, and the negative (−) electrical side of the electrical wires is shown in solid lines for illustrative purposes.

The predetermined resistance for each of the components 16 is pre-assigned, and is stored in the library 32 of the host machine 26, such as in a look-up table, a database, etc. Generally, the components 16 are assembled relative to each other such that the resistor 48 of each of the components 16 close a loop of the electrical circuitry 46 to provide a sum of resistance as the unique identification information. The host machine 26 is configured to calculate the sum of resistance as the unique identification information.

A power source 50 applies a voltage through each electrical circuit and the resulting current is measured. Therefore, the voltage applied to the electrical circuitry 46 is predetermined or known, and the measured current is known, now the resistance can be calculated by Ohm's Law, i.e., voltage equals current times resistance (V=I×R, where V=voltage, I=current, and R=resistance). The current through the electrical circuitry 46 may be measured by any suitable device, and one non-limiting example is an ammeter.

The calculated resistance, i.e., the sum of resistance, is then compared to the assigned predetermined resistance for each of the components 16 via the host machine 26. The host machine 26 may store and retrieve the assigned predetermined resistance, which corresponds to stored information about that particular component 16, for each of the components 16 in the library 32, and then use this information to compare the actual calculated resistance from the installed scale model 14 with the assigned predetermined resistance for each of the components 16.

It is to be appreciated that different ones of the identifiers 24 may be combined together for the installed scale model 14. Therefore, for example, one or more of the components 16 having the identifier(s) 24 being the TEDS chip 40/the TEDS network 44 configuration and/or one or more of the components 16 having the identifier(s) 24 being the RFID tag 36/the RFID reader 38 configuration and/or one or more of the components 16 having the identifier(s) 24 being the electrical circuitry 46/the resistor 48 may be combined together for the installed scale model 14. It is to be appreciated that the host machine 26 is configured to communicate with any combination of the different identifiers 24.

Regardless of the configuration of the identifier 24 as discussed with FIGS. 2-5, the host machine 26 is configured to output a notification 52 if the selected data does not match the unique identification information. By notifying the user of the mismatch of information, undesirable testing may be avoided. Therefore, the present disclosure assures that the desired model configuration is actually/physically installed in the testing tunnel 12, and thus, results from the test run are related to the expected desired model configuration. That is, the present disclosure provides that the user that chose the desired model configuration to be tested matches the user's expectation and is accurately logged for each of the test runs.

The notification 52 may be an alert or an alarm, and the notification 52 may be automatically outputted. Therefore, the host machine 26 may output the notification 52, and the notification 52 may be presented in any suitable way, and one non-limiting example is via the interface 35 of the host machine 26.

For example, the notification 52 may include a visual indicator. Non-limiting examples of the visual indicator may include the interface 35, such as the display, a screen, a light, multi-colored lights, etc., and combinations thereof. The visual indicator may provide various information to the user about which of the components 16 is improper.

As another example, the notification 52 may include an auditory indicator. Non-limiting examples of the auditory indicator may include the interface 35, such as the speaker, a buzzer, a noise, beeping, a horn, music, etc., and combinations thereof.

As yet another example, the notification 52 may include a locking feature that prevents operation of the testing tunnel 12. Therefore, for example, the locking feature may be where the host machine 26 may be in communication with one or more structures of the testing tunnel 12, in which the host machine 26 may signal the one or more structures to remain off or shut off. As another example, the locking feature may be a lock, and the host machine 26 may communicate with the lock to signal the lock to engage one or more structures of the testing tunnel 12 to prevent operation of the testing tunnel 12. As yet another example, the locking feature may be where the host machine 26 prevents operation of the testing tunnel 12 electronically.

It is to be appreciated that the notification 52 may include one or more than one way to signal to the user that the selected data does not match the unique identification information. As an example, the notification 52 may include the visual indicator and/or the auditory indicator and/or the locking feature.

If a notification 52 is received, the improper components 16 may be removed and replaced by the intended or proper component 16. Next, some of the interchangeability is discussed. Generally, the components 16 include a base component 16 and a plurality of interchangeable components 16 interchangeably attached to the base component 16. The base component 16 may be interchanged with other base components 16 as well. The base component 16 and each of the interchangeable components 16 may be different from each other. As one non-limiting example, the base component 16 may be the fuselage 18 and the interchangeable components 16 may be different wing 20 configurations. As another non-limiting example, the base component 16 may be a wing 20 and the interchangeable components 16 may be different high-lift devices 22A, 22B or control surfaces, such as different flap configurations, different slat configurations, and/or different aileron configurations. It is to be appreciated that each test run may have the high-lift devices 22A, 22B or control surfaces at a different position, and therefore, may be disposed different angles relative to the wing 20.

Generally, the base component 16 may include at least one identifier 24 and the interchangeable components 16 may each include at least one identifier 24. In certain configurations, the base component 16 and/or the interchangeable components 16 may include more than one identifier 24. Therefore, for example, if the wing 20 includes flaps and slats, then the base component 16 may include more than one identifier 24 depending on the type of identifier 24 being used (for example, the wing 20 may include a resistor 48 that cooperates with the resistor 48 of the flap, and another resistor 48 that cooperates with the resistor 48 of the slat).

Furthermore, in certain configurations, the base component 16 may include a plurality of base components 16 each being a different configuration. For example, the base component 16 may include a plurality of the fuselages 18 of the aircraft. In other configurations, the base component 16 may include a plurality of the wings 20 of the aircraft. The base components 16 may be any suitable component 16, and non-limiting examples are discussed herein.

In certain configurations, the interchangeable components 16 may include a plurality of the wings 20 of the aircraft and a plurality of the high-lift devices 22A, 22B of the wing 20. The high-lift devices 22A, 22B may include flaps, slats, or any other suitable high-lift devices 22A, 22B as mentioned above. As one non-limiting example, one of the plurality of high-lift devices 22A, 22B is attached to a selected one of the wings 20 to define the selected one of the wings 20 having the selected one of the high-lift devices 22A, 22B thereon. The selected one of the wings 20 is attached to a selected one of the fuselages 18 to form the first model configuration.

Generally, the host machine 26 is configured to identify, via the identifier 24, the components 16, such as the selected base component 16 and the selected interchangeable components 16, in the first model configuration of the scale model 14 installed in the testing tunnel 12. The host machine 26 is used to notify the user if there is an undesirable component 16 assembled for a chosen model configuration. That is, the host machine 26 may be configured to identify any of the base components 16 and the interchangeable components 16 that caused the notification 52 to occur to define an improper component 16. Once the user is notified of the improper component 16, via the notification 52, the improper component 16 may be interchanged with the intended component 16. Therefore, the improper component 16 is detached from the selected one of the base components 16 or detached from the selected one of the interchangeable components 16 of the first model configuration. Then, a proper component 16 is attached to the selected one of the base components 16 or attached to the selected one of the interchangeable components 16 to form a corrected first model configuration. Then, the host machine 26 may be configured to identify, via the identifier 24, each of the components 16, including the base components 16 and the interchangeable components 16, installed in the testing tunnel 12 for the corrected first model configuration. The host machine 26 may be configured to receive, via the host machine 26, the unique identification information from the components 16 of the corrected first model configuration. In addition, the host machine 26 may be configured to determine if the unique identification information for the corrected first model configuration corresponds to the selected data of the desired model to be installed. If the selected data matches the unique identification information for the corrected first model configuration, then operation of the testing tunnel 12, such as the fluid testing tunnel, is allowed. Therefore, the present disclosure ensures that desired model configuration is installed and tested.

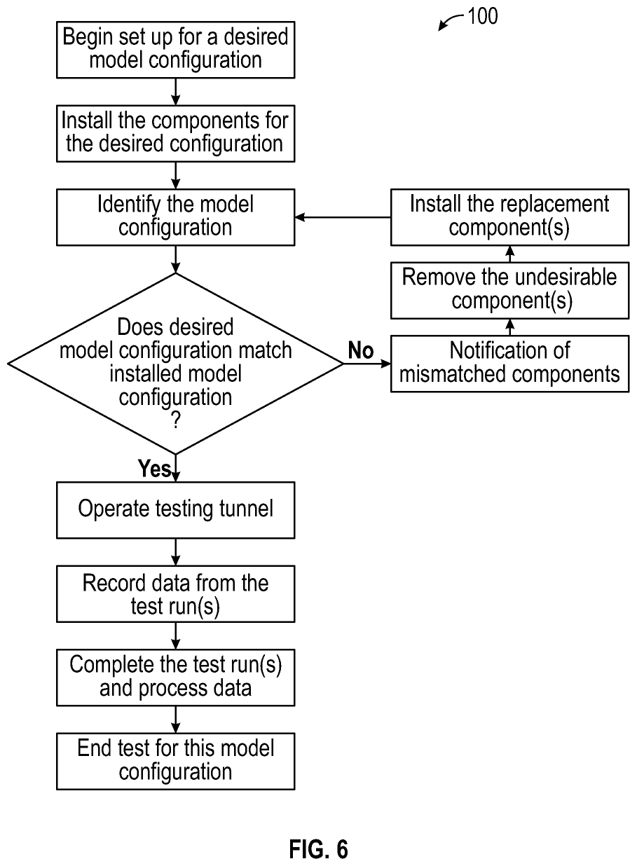

The present disclosure also provides a method 100 of modeling the aircraft in the testing tunnel 12. One non-limiting configuration of the method 100 may be found in FIG. 6. It is to be appreciated that the order or sequence of performing the method 100 as identified in the flowchart of FIG. 6 is for illustrative purposes, and other orders or sequences are within the scope of the present teachings. It is to also be appreciated that the method 100 may include other features not specifically identified in the flowchart of FIG. 6.

The type of the testing tunnel 12 is selected, and the desired/selected model configuration and associated components 16 are installed in the testing tunnel 12. Therefore, for example, if aerodynamic testing is desired, a wind tunnel may be selected to perform the test run(s).

Next, the user may select the desired components 16 to be installed in the testing tunnel 12, to define the desired model configuration, such as the first model configuration to be installed. The host machine 26 may be used to select data about the components 16 installed for the first model configuration. Generally, the memory 28 of the host machine 26 may include the library 32 containing the plurality of possible components 16 to be used to form the model configuration including the first model configuration. Selecting the data may include accessing the library 32 via the processor 30 and selecting the components 16 from the possible components 16 as the data from the library 32.

The information about the selected components 16 may be stored in the host machine 26 and used at a later time. Once the desired model configuration is determined, the components 16 of the scale model 14 are installed in the testing tunnel 12, to define the actual-installed model configuration, which should match the desired model configuration. Therefore, the components 16 installed in the testing tunnel 12 are to form the first model configuration.

As discussed above, the components 16 that are installed in the testing tunnel 12 are the scale model 14 of the aircraft, and each of the components 16 include the identifier 24 having the unique identification information for the respective components 16. The identifier 24 is identified for each of the components 16 installed in the testing tunnel 12 for the first model configuration. Therefore, for example, after the scale model 14 has been installed in the testing tunnel 12, the identifier 24 is used to confirm the model configuration that is actually installed. The identifier 24 may be identified by any suitable way, and non-limiting examples are discussed below. The host machine 26 receives the unique identification information, via the identifier 24. from the components 16 of the first model configuration.

As one example, the identifier 24 may include the RFID tag 36 that stores the unique identification information for each of the components 16, and the host machine 26 may include the RFID reader 38 configured to receive the unique identification information from each identifier 24. In this configuration, identifying each of the components 16 installed in the testing tunnel 12 for the first model configuration may include identifying, via the RFID tag 36, each of the components 16 installed in the testing tunnel 12 and accessing the unique identification information via the RFID reader 38. The RFID reader 38 may be disposed in the vicinity of the RFID tag 36 such that the RFID reader 38 receives the unique identification information for the installed components 16.

As another example, the identifier 24 may include the TEDS chip 40 having the transducer 42, and the TEDS chip 40 stores the unique identification information for each of the components 16. The host machine 26 may include the TEDS network 44 configured to receive the unique identification information from each identifier 24 via the transducer 42 of the TEDS chip 40. In this configuration, identifying each of the components 16 installed in the testing tunnel 12 for the first model configuration may include identifying, via the TEDS chip 40, each of the components 16 installed in the testing tunnel 12 and accessing the unique identification information via the TEDS network 44. Therefore, in this configuration, once the scale model 14 is actually/physically installed in the testing tunnel 12, the TEDS network 44 may automatically communicate the unique identification information for the installed components 16 to the host machine 26.

As yet another example, each of the components 16 may include the electrical circuitry 46, and the identifier 24 may include the resistor 48 having the predetermined resistance for each of the components 16. In this configuration, installing the components 16 may include assembling the components 16 relative to each other such that the resistor 48 of each of the components 16 close the loop of the electrical circuitry 46 to provide the sum of resistance as the unique identification information. In addition, for this configuration, receiving the unique identification information may include calculating the sum of resistance via the host machine 26. Therefore, in this configuration, once the scale model 14 is actually/physically installed in the testing tunnel 12, the power supply may be applied to the electrical circuitry 46 and the resistance measured, the measured resistance may be automatically communicated to the host machine 26, and the host machine 26 calculates the sum of resistance as the unique identification information for the installed components 16.

The method 100 then determines if the unique identification information corresponds to the selected data. For example, the host machine 26 may compare each of the components 16 of the desired/selected first model configuration (which will be referred to as the intended first model configuration) to be installed with each of the components 16 that are actually installed in the testing tunnel 12 that should form the first model configuration (which will be referred to as the actual installed first model configuration).

The notification 52 is outputted if the selected data does not match the unique identification information. Therefore, when the host machine 26 compares the intended first model configuration with the actual installed first model configuration, and the data does not match, then the notification 52 will be outputted to inform the user that one or more of the components 16 need to be changed out, as discussed further below. If no notification 52 is outputted, then the selected data matches the unique identification information, and the user is ensured that the desired/selected first model configuration is the model configuration that the test run will collect results for.

If the notification 52 is outputted, the notification 52 may be conveyed in one or more ways. As one non-limiting example, outputting the notification 52 may include outputting the visual indicator if the selected data does not match the unique identification information. As another example, outputting the notification 52 may include outputting the auditory indicator if the selected data does not match the unique identification information. As yet another example, outputting the notification 52 may include activating the locking feature that prevents operation of the testing tunnel 12 if the selected data does not match the unique identification information. Details of the visual indicator, the auditory indicatory, and the locking feature are discussed above, and will not be repeated.

If the notification 52 is outputted, the user is notified that one or more of the installed components 16 should be removed and replaced by a different component 16. That is, the host machine 26 may be configured to identify which of the components 16 does not match the components 16 of the intended first model configuration. The host machine 26 may communicate to the user which of the components 16 needs to be removed and replaced. Therefore, identification of which of the components 16 to be removed may be conveyed to the user via the interface 35, such as the display and/or the speaker, or communicated to the user by any other suitable way(s).

Next, the one or more of the components 16 is removed from the first model configuration that does not match the selected data due to the outputted notification 52. The removed one or more of the components 16 is then replaced with a proper one or more of the components 16 to form a corrected first model configuration. Next, the method 100 repeats the initial steps discussed above to determine whether the corrected first model configuration matches the intended first model configuration. Therefore, the identifier 24 is identified for each of the components 16 installed in the testing tunnel 12 for the corrected first model configuration. The host machine 26 receives the unique identification information from the components 16 of the corrected first model configuration. Next, the method 100 determines if the unique identification information for the corrected first model configuration corresponds to the selected data (of the intended first model configuration). The host machine 26 may compare each of the components 16 of the intended first model configuration to be installed with each of the components 16 that are actually installed in the testing tunnel 12 (now the corrected first model configuration) that should form the first model configuration.

If the corrected first model configuration does not match the intended first model configuration, then another notification 52 will be outputted and the steps of identifying which of the component(s) 16 do not match the components 16 of the intended first model configuration, and removing and replacing one or more of the components 16, and so on are repeated until the actual-installed first model configuration matches the intended first model configuration. Then, the test tunnel may be operated if the selected data (of the intended first model configuration) matches the unique identification information for the corrected first model configuration. When no notification 52 is outputted, the user is ensured that the desired/selected first model configuration is the model configuration that the test run will collect results for.

The present disclosure provides improved tunnel testing by more accurately tracking data and the components 16 of the scale model 14, which correspondingly improves productivity of the testing tunnel 12 and the results of the test runs of the testing tunnel 12. That is, for example, by using the identifiers 24, human errors or mistakes may be reduced. Therefore, the present disclosure results in savings by reducing rework due to erroneous results and by reducing erroneous data being initially logged. That is, by eliminating manual entry of bookkeeping, data generation, retrieval, and handling are improved by the electronic system 10 and the method 100 described herein.

While the best modes and other configurations for carrying out the disclosure have been described in detail, those familiar with the art to which this disclosure relates will recognize various alternative designs and configurations for practicing the disclosure within the scope of the appended claims. Furthermore, the configurations shown in the drawings or the characteristics of various configurations mentioned in the present description are not necessarily to be understood as configurations independent of each other. Rather, it is possible that each of the characteristics described in one of the examples of a configuration can be combined with one or a plurality of other desired characteristics from other configurations, resulting in other configurations not described in words or by reference to the drawings. Accordingly, such other configurations fall within the framework of the scope of the appended claims.

As used herein, a system, apparatus, structure, article, clement, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The illustrations of the configurations described herein are intended to provide a general understanding of the structure of the various configurations. The illustrations are not intended to serve as a complete description of all of the elements and features of apparatus and systems that utilize the structures or methods described herein. Many other configurations may be apparent to those of skill in the art upon reviewing the disclosure. Other configurations may be utilized and derived from the disclosure, such that structural and logical substitutions and changes may be made without departing from the scope of the disclosure. Accordingly, the disclosure and the figures are to be regarded as illustrative rather than restrictive.

The following Clauses provide some example configurations of the electronic system, the aircraft, and the method as disclosed herein.

Clause 1: An electronic system for modeling an aircraft in a testing tunnel, the electronic system comprising: a scale model of the aircraft that includes a plurality of components installed in the testing tunnel to form a first model configuration; wherein each of the components include an identifier having unique identification information for the respective components, wherein each of the components is identifiable by the identifier when the respective components are installed in the testing tunnel for the first model configuration; a host machine configured to select data about the components installed for the first model configuration, wherein the host machine is configured to execute instructions from a memory, via a processor; and wherein the host machine is configured to: receive the unique identification information from the components of the first model configuration; determine if the unique identification information corresponds to the selected data; and output a notification if the selected data does not match the unique identification information.

Clause 2: The electronic system of clause 1 wherein the identifier includes a radio frequency identification (RFID) tag that stores the unique identification information for each of the components, and the host machine includes an RFID reader configured to receive the unique identification information from each identifier, and wherein the host machine is configured to receive the unique identification information from the RFID reader.

Clause 3: The electronic system of any one of the preceding clauses wherein the identifier includes a transducer electronic data sheet (TEDS) chip having a transducer, and the TEDS chip stores the unique identification information for each of the components, and the host machine includes a TEDS network configured to receive the unique identification information from each identifier via the transducer of the TEDS chip.

Clause 4: The electronic system of any one of the preceding clauses wherein each of the components include electrical circuitry, and wherein the identifier includes a resistor having a predetermined resistance for each of the components, and wherein the components are assembled relative to each other such that the resistor of each of the components close a loop of the electrical circuitry to provide a sum of resistance as the unique identification information, and wherein the host machine is configured to calculate the sum of resistance as the unique identification information.

Clause 5: The electronic system of any one of the preceding clauses wherein the notification includes a visual indicator.

Clause 6: The electronic system of any one of the preceding clauses wherein the notification includes an auditory indicator.

Clause 7: The electronic system of any one of the preceding clauses wherein the notification includes a locking feature that prevents operation of the testing tunnel.

Clause 8: The electronic system of any one of the preceding clauses wherein: the components include a base component and a plurality of interchangeable components interchangeably attached to the base component; the base component and each of the interchangeable components are different from each other; and the base component includes at least one identifier and the interchangeable components each include at least one identifier.

Clause 9: The electronic system of clause 8 wherein: the base component includes a plurality of fuselages of the aircraft; the interchangeable components include a plurality of wings of the aircraft and a plurality of high-lift devices of the wing; one of the plurality of high-lift devices is attached to a selected one of the wings to define the selected one of the wings having the selected one of the high-lift devices thereon, and the selected one of the wings is attached to a selected one of the fuselages to form the first model configuration; and the testing tunnel includes a fluid testing tunnel configured to receive the first model configuration.

Clause 10: The electronic system of any one of the preceding clauses wherein the fluid testing tunnel is a wind testing tunnel, and wherein the host machine is configured to store, via the memory, results from operation of the wind testing tunnel of the first model configuration in an aerodynamic database of the memory.

Clause 11: The electronic system of clause 9 wherein: the host machine is configured to identify any of the base components and the interchangeable components that caused the notification to occur to define an improper component; the improper component is detached from the selected one of the base components or detached from the selected one of the interchangeable components of the first model configuration; a proper component is attached to the selected one of the base components or attached to the selected one of the interchangeable components to form a corrected first model configuration; and the host machine is configured to: identify, via the identifier, each of the components, including the base components and the interchangeable components, installed in the testing tunnel for the corrected first model configuration; receive, via the host machine, the unique identification information from the components of the corrected first model configuration; determine if the unique identification information for the corrected first model configuration corresponds to the selected data; and allow operation of the fluid testing tunnel if the selected data matches the unique identification information for the corrected first model configuration.

Clause 12: A method of modeling an aircraft in a testing tunnel, the method comprising: installing a plurality of components in the testing tunnel to form a first model configuration, wherein the components installed in the testing tunnel are a scale model of the aircraft, and each of the components includes an identifier having unique identification information for the respective components; selecting data, via a host machine, about the components installed for the first model configuration, wherein the host machine is configured to execute instructions from a memory, via a processor; identifying, via the identifier, each of the components installed in the testing tunnel for the first model configuration; receiving via the host machine the unique identification information from the components of the first model configuration; determining if the unique identification information corresponds to the selected data; and outputting a notification if the selected data does not match the unique identification information.

Clause 13: The method of clause 12 wherein the identifier includes a radio frequency identification (RFID) tag that stores the unique identification information for each of the components, and the host machine includes an RFID reader configured to receive the unique identification information from each identifier, wherein identifying each of the components installed in the testing tunnel for the first model configuration includes identifying, via the RFID tag, each of the components installed in the testing tunnel and accessing the unique identification information via the RFID reader.

Clause 14: The method of any one of clauses 12 or 13 wherein the identifier includes a transducer electronic data sheet (TEDS) chip having a transducer, and the TEDS chip stores the unique identification information for each of the components, and the host machine includes a TEDS network configured to receive the unique identification information from each identifier via the transducer of the TEDS chip, wherein identifying each of the components installed in the testing tunnel for the first model configuration includes identifying, via the TEDS chip, each of the components installed in the testing tunnel and accessing the unique identification information via the TEDS network.

Clause 15: The method of any one of clauses 12-14 wherein each of the components include electrical circuitry, and wherein the identifier includes a resistor having a predetermined resistance for each of the components, and wherein installing the components includes assembling the components relative to each other such that the resistor of each of the components close a loop of the electrical circuitry to provide a sum of resistance as the unique identification information, and wherein receiving the unique identification information includes calculating the sum of resistance via the host machine.

Clause 16: The method of any one of clauses 12-15 wherein the memory of the host machine includes a library containing a plurality of possible components to be used to form a model configuration including the first model configuration, wherein selecting the data includes accessing the library via the processor and selecting the components from the possible components as the data from the library.

Clause 17: The method of any one of clauses 12-16 wherein outputting the notification includes outputting a visual indicator if the selected data does not match the unique identification information.

Clause 18: The method of any one of clauses 12-17 wherein outputting the notification includes outputting an auditory indicator if the selected data does not match the unique identification information.

Clause 19: The method of any one of clauses 12-18 wherein outputting the notification includes activating a locking feature that prevents operation of the testing tunnel if the selected data does not match the unique identification information.

Clause 20: The method of clause 12 further comprising: removing one or more of the components from the first model configuration that does not match the selected data due to the outputted notification; replacing the removed one or more of the components with a proper one or more of the components to form a corrected first model configuration; identifying, via the identifier, each of the components installed in the testing tunnel for the corrected first model configuration; receiving, via the host machine, the unique identification information from the components of the corrected first model configuration; determining if the unique identification information for the corrected first model configuration corresponds to the selected data; and operating the test tunnel if the selected data matches the unique identification information for the corrected first model configuration.

What is claimed is:

1. An electronic system for modeling an aircraft in a testing tunnel, the electronic system comprising:
a scale model of the aircraft that includes a plurality of components installed in the testing tunnel to form a first model configuration;
wherein each of the components include an identifier having unique identification information for the respective components, wherein each of the components is identifiable by the identifier when the respective components are installed in the testing tunnel for the first model configuration;
a host machine configured to select data about the components installed for the first model configuration, wherein the host machine is configured to execute instructions from a memory, via a processor; and
wherein the host machine is configured to:
receive the unique identification information from the components of the first model configuration;
determine if the unique identification information corresponds to the selected data; and
output a notification if the selected data does not match the unique identification information.

2. The electronic system of claim 1 wherein the identifier includes a radio frequency identification (RFID) tag that stores the unique identification information for each of the components, and the host machine includes an RFID reader configured to receive the unique identification information from each identifier, and wherein the host machine is configured to receive the unique identification information from the RFID reader.

3. The electronic system of claim 1 wherein the identifier includes a transducer electronic data sheet (TEDS) chip having a transducer, and the TEDS chip stores the unique identification information for each of the components, and the host machine includes a TEDS network configured to receive the unique identification information from each identifier via the transducer of the TEDS chip.

4. The electronic system of claim 1 wherein each of the components include electrical circuitry, and wherein the identifier includes a resistor having a predetermined resistance for each of the components, and wherein the components are assembled relative to each other such that the resistor of each of the components close a loop of the electrical circuitry to provide a sum of resistance as the unique identification information, and wherein the host machine is configured to calculate the sum of resistance as the unique identification information.

5. The electronic system of claim 1 wherein the notification includes a visual indicator.

6. The electronic system of claim 1 wherein the notification includes an auditory indicator.

7. The electronic system of claim 1 wherein the notification includes a locking feature that prevents operation of the testing tunnel.

8. The electronic system of claim 1 wherein:
the components include a base component and a plurality of interchangeable components interchangeably attached to the base component;
the base component and each of the interchangeable components are different from each other; and
the base component includes at least one identifier and the interchangeable components each include at least one identifier.

9. The electronic system of claim 8 wherein:
the base component includes a plurality of fuselages of the aircraft;
the interchangeable components include a plurality of wings of the aircraft and a plurality of high-lift devices of the wing;
one of the plurality of high-lift devices is attached to a selected one of the wings to define the selected one of the wings having the selected one of the high-lift devices thereon, and the selected one of the wings is attached to a selected one of the fuselages to form the first model configuration; and
the testing tunnel includes a fluid testing tunnel configured to receive the first model configuration.

10. The electronic system of claim 9 wherein the fluid testing tunnel is a wind testing tunnel, and wherein the host machine is configured to store, via the memory, results from operation of the wind testing tunnel of the first model configuration in an aerodynamic database of the memory.

11. The electronic system of claim 9 wherein:
the host machine is configured to identify any of the base components and the interchangeable components that caused the notification to occur to define an improper component;
the improper component is detached from the selected one of the base components or detached from the selected one of the interchangeable components of the first model configuration;
a proper component is attached to the selected one of the base components or attached to the selected one of the interchangeable components to form a corrected first model configuration; and
the host machine is configured to:
identify, via the identifier, each of the components, including the base components and the interchangeable components, installed in the testing tunnel for the corrected first model configuration;
receive, via the host machine, the unique identification information from the components of the corrected first model configuration;
determine if the unique identification information for the corrected first model configuration corresponds to the selected data; and
allow operation of the fluid testing tunnel if the selected data matches the unique identification information for the corrected first model configuration.

12. A method of modeling an aircraft in a testing tunnel, the method comprising:
installing a plurality of components in the testing tunnel to form a first model configuration, wherein the components installed in the testing tunnel are a scale model of the aircraft, and each of the components includes an identifier having unique identification information for the respective components;
selecting data, via a host machine, about the components installed for the first model configuration, wherein the host machine is configured to execute instructions from a memory, via a processor;
identifying, via the identifier, each of the components installed in the testing tunnel for the first model configuration;
receiving via the host machine the unique identification information from the components of the first model configuration;
determining if the unique identification information corresponds to the selected data; and
outputting a notification if the selected data does not match the unique identification information.

13. The method of claim 12 wherein the identifier includes a radio frequency identification (RFID) tag that stores the unique identification information for each of the components, and the host machine includes an RFID reader configured to receive the unique identification information from each identifier, wherein identifying each of the components installed in the testing tunnel for the first model configuration includes identifying, via the RFID tag, each of the components installed in the testing tunnel and accessing the unique identification information via the RFID reader.

14. The method of claim 12 wherein the identifier includes a transducer electronic data sheet (TEDS) chip having a transducer, and the TEDS chip stores the unique identification information for each of the components, and the host machine includes a TEDS network configured to receive the unique identification information from each identifier via the transducer of the TEDS chip, wherein identifying each of the components installed in the testing tunnel for the first model configuration includes identifying, via the TEDS chip, each of the components installed in the testing tunnel and accessing the unique identification information via the TEDS network.

15. The method of claim 12 wherein each of the components include electrical circuitry, and wherein the identifier includes a resistor having a predetermined resistance for each of the components, and wherein installing the components includes assembling the components relative to each other such that the resistor of each of the components close a loop of the electrical circuitry to provide a sum of resistance as the unique identification information, and wherein receiving the unique identification information includes calculating the sum of resistance via the host machine.

16. The method of claim 12 wherein the memory of the host machine includes a library containing a plurality of possible components to be used to form a model configuration including the first model configuration, wherein selecting the data includes accessing the library via the processor and selecting the components from the possible components as the data from the library.

17. The method of claim 12 wherein outputting the notification includes outputting a visual indicator if the selected data does not match the unique identification information.

18. The method of claim 12 wherein outputting the notification includes outputting an auditory indicator if the selected data does not match the unique identification information.

19. The method of claim 12 wherein outputting the notification includes activating a locking feature that prevents operation of the testing tunnel if the selected data does not match the unique identification information.

20. The method of claim 12 further comprising:
removing one or more of the components from the first model configuration that does not match the selected data due to the outputted notification;
replacing the removed one or more of the components with a proper one or more of the components to form a corrected first model configuration;
identifying, via the identifier, each of the components installed in the testing tunnel for the corrected first model configuration;
receiving, via the host machine, the unique identification information from the components of the corrected first model configuration;
determining if the unique identification information for the corrected first model configuration corresponds to the selected data; and
operating the test tunnel if the selected data matches the unique identification information for the corrected first model configuration.
